(19) United States
(12) Patent Application Publication
(10) Pub. No.: US 2012/0223918 A1
(43) Pub. Date: Sep. 6, 2012

(54) LATCHING DEVICE AND STYLUS USING SAME

(75) Inventor: QIN LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/271,369

(22) Filed: Oct. 12, 2011

(30) Foreign Application Priority Data
Mar. 2, 2011 (CN) 201110049909.2

(51) Int. Cl. G06F 3/033

(52) U.S. Cl. 345/179

(57) ABSTRACT

A stylus with several parts includes a first housing, a second housing and a latching device. The latching device includes a hook and a latching element engaging the hook. One of the hook and the latching element protrudes from the first housing, the other one protrudes from the second housing. The latching element defines a guiding receiving space at a distal end thereof and a latching receiving space near a proximal end thereof, the guiding receiving space communicates with the latching receiving space and guides the hook to the latching receiving space so that the hook is latched in the latching receiving space.

### BACKGROUND

1. Technical Field

This exemplary disclosure generally relates to styluses, particular to a stylus with a latching device.

2. Description of Related Art

Many devices include a touch screen. Examples of such devices include smart phones, personal digital assistants (PDA), pagers, personal organizers, and the like. These devices typically include a display module under the touch screen. The display module generates target images associated with menu options, programs, user choices, and other operations. The user may control the device by pressing the touch screen over the target image with a stylus. The stylus body of a typical stylus may include a first housing and a second housing. The first housing includes a hook, and the second housing includes a latching hole. The hook is latched into the latching hole so the first housing is latched to the second housing. However, the hook is typically made of fragile material that may be easily broken as the hook is latched to the latching hole.

Therefore, there is room for improvement within the art

### BRIEF DESCRIPTION OF THE DRAWINGS

Many aspects of the exemplary stylus can be better understood with reference to the following drawings. The components in the various drawings are not necessarily drawn to scale, the emphasis instead being placed upon clearly illustrating the principles of the exemplary stylus with a latching device. Moreover, in the drawings, like reference numerals designate corresponding parts throughout the diagrams.

FIG. 1 is an exploded view of a stylus with an exemplary embodiment of a latching device, the stylus including a first housing, a second housing and the latching device.

FIG. 2 is an enlarged view of part of the second housing of FIG. 1.

FIG. 3 is a view of the assembled stylus shown in FIG. 1.

FIG. 3 is a cross sectional view of the stylus shown in FIG. 3.

### DETAILED DESCRIPTION

In this exemplary embodiment, the stylus is used to contact a touch screen of an electronic device such as a mobile telephone. The mobile telephone described herein is representative of the type of wireless communication device that may benefit from the exemplary embodiment. However, it is to be understood that the exemplary embodiment may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or a DVD player) that have wireless communication capability and the like. Accordingly, any reference herein to a mobile telephone should also be considered to apply equally to other portable wireless electronic devices.

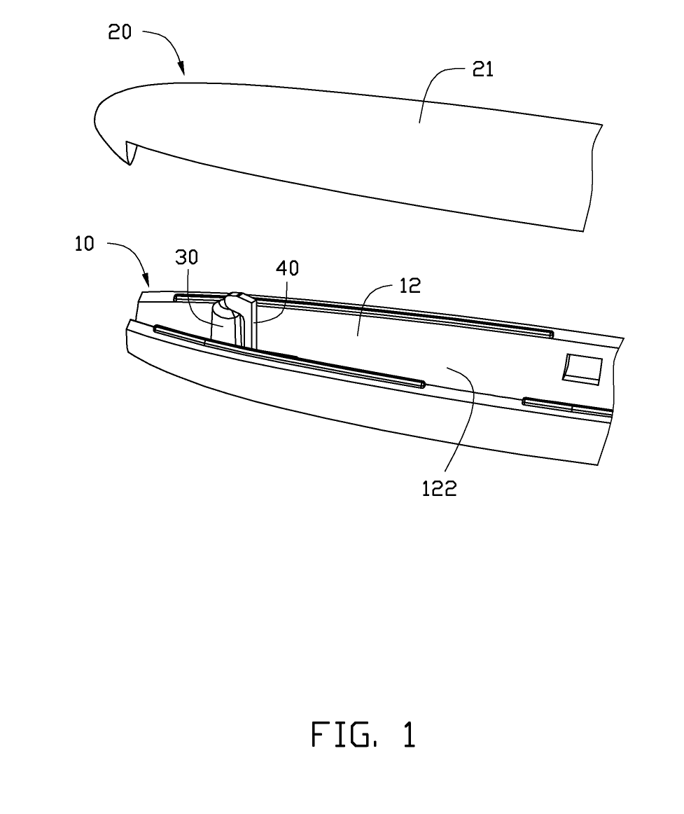

Referring to FIG. 1, the stylus includes a first housing 10, a second housing 20 and a latching device (not labeled). The latching device latches the first housing 10 to the second housing 20. In this exemplary embodiment, the first housing 10, the second housing 20 and the latching device are all made of conductive material, such as stainless steel.

Referring to FIG. 1, the first housing 10 is semi-cylindrical and longitudinally defines a first receiving space 12. The first housing 10 further includes a first inner surface 122 in the first receiving space 12.

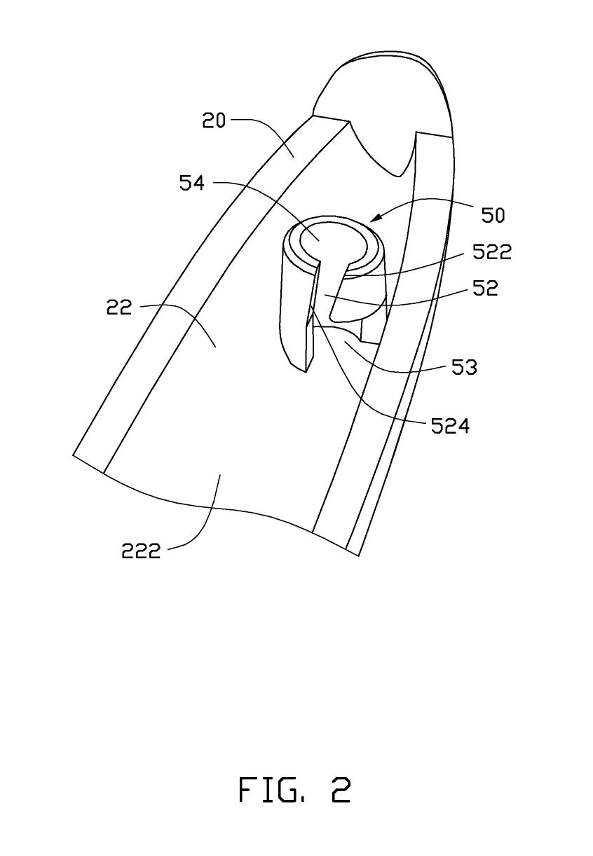

Referring to FIG. 2, the second housing 20 is also semi-cylindrical and longitudinally defines a second receiving space 22. The second housing 20 further includes a second inner surface 222 in the second receiving space 22.

Referring to FIGS. 1-2 and 4, the latching device is located between the inner surfaces of the first housing 10 and the second housing 20, and attach between the inner surfaces of the first housing 10 and the second housing 20. The latching device, in this exemplary embodiment, includes a bracket in the shape of an inverted “L” (hook 40) and a latching element 50 that engages the hook 40. The hook 40 protrudes from the first inner surface 122 and the latching element 50 protrudes from the second inner surface 222. The hook 40 may be positioned on either the first inner surface 122 or the second inner surface 222 and the hook engaging members (e.g. the latching element 50) may be positioned on the element opposite the hook 40. In this exemplary embodiment, the latching element 50 is a hollow cylindrical boss protruding from the second inner surface 222, with sections cut away so as to define a guiding receiving space 52 at the distal end thereof and a latching receiving space 53 near/at the proximal end thereof. The guiding receiving space 52 communicates with the latching receiving space 53 and guides the hook 40 to the latching receiving space 53 so the hook 40 is secured in the latching receiving space 53. In this exemplary embodiment, the guiding receiving space 52 is defined by a first guiding surface 522 and an opposite second guiding surface 524. In this embodiment, both the first guiding surface 522 and the substantially parallel second guiding surface 524 extend in direction A, which intersects with, but diverges from, the axial direction B of the boss so the guiding receiving space 52 extends in the direction A intersected with the direction B.

Referring to FIGS. 1-2 and 4, the latching device further includes a positioning pole 30 and a positioning hole 54. The positioning pole 30 and the positioning hole 54 are so sized and shaped and positioned that the first housing 10 is stably and securely latched to the second housing 20. The positioning pole 30 protrudes from the first inner surface 122 and is near the hook 40. The positioning hole 54 is defined in the boss and communicates with the guiding receiving space 52 and the latching receiving space 53. The positioning pole 30 may be positioned on either the first inner surface 122 or on the boss and the positioning pole 54 may be positioned on the element opposite the positioning pole 30.

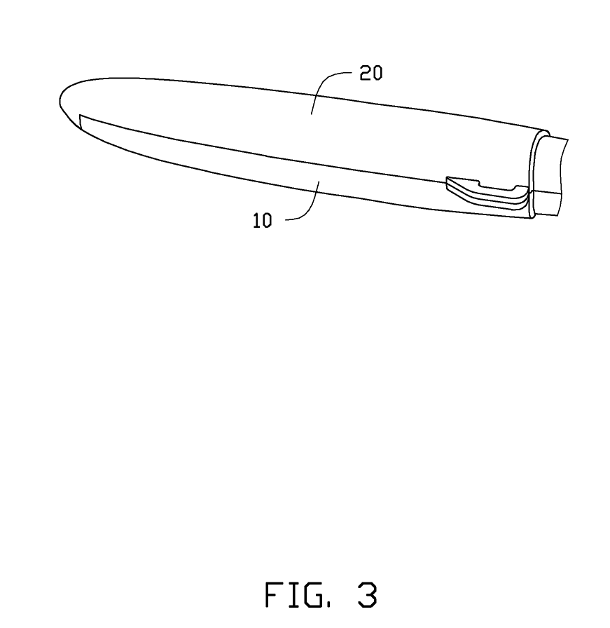

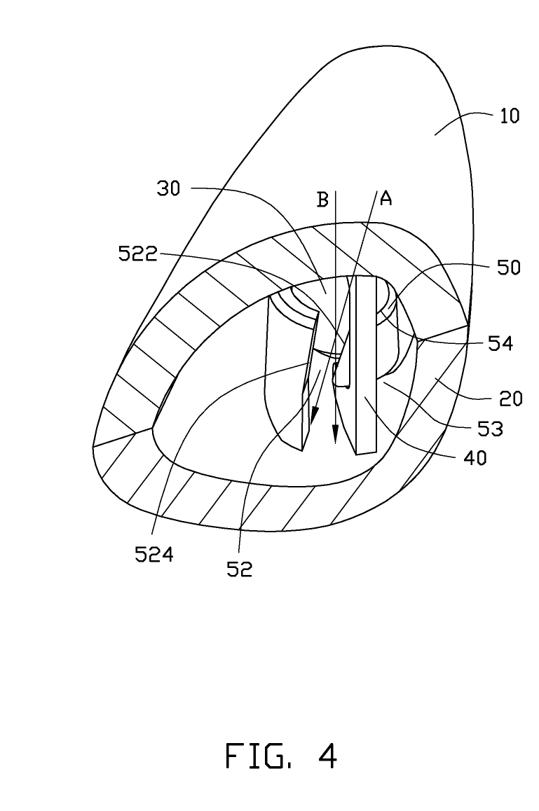

Referring to FIGS. 3 and 4, in assembly, the positioning pole 30 is aligned with the positioning hole 54 and the hook 40 is aligned with the guiding receiving space 52. The first housing 10 is pressed toward the second housing 20 with the hook 40 moving in the guiding receiving space 52. Because the guiding receiving space 52 extends in the direction A which intersects with the axial direction B of the boss, the hook 40 will be slightly deformed elastically by the first guiding receiving space surface 522. After the hook 40 has crossed the first guiding surface 522, the hook 40 is released from deformation and engages with the latching receiving space 53 so the hook 40 is latched in the latching receiving space 53, and the positioning pole 30 in the positioning hole 54 provide positional support and fixity to the attachment between the inner surfaces of the first housing 10 and the second housing 20.

It is to be further understood that even though numerous characteristics and advantages of the exemplary embodiments have been set forth in the foregoing description, together with details of the structures and functions of various embodiments, the disclosure is illustrative only, and changes may be made in detail, especially in the matters of shape, size, and arrangement of parts within the principles of the exemplary invention to the full extent indicated by the broad general meaning of the terms in which the appended claims are expressed.

What is claimed is:

1. A stylus, comprising:
a first housing;
a second housing; and
a latching device comprising a hook and a latching element engaging the hook, one of the hook and the latching element protruding from an inner surface of the first housing, the other one protruding from an inner surface of the second housing;
wherein the latching element defines a guiding receiving space at a distal end thereof and a latching receiving space near a proximal end thereof, the guiding receiving space communicates with the latching receiving space and guides the hook toward the latching receiving space so the hook latches in the latching receiving space.

2. The stylus as claimed in claim 1, wherein the guiding receiving space extends in a first direction intersected with a longitudinal direction of the latching element.

3. The stylus as claimed in claim 2, wherein the guiding receiving space is defined by a first guiding surface and an opposite second guiding surface; both the first guiding surface and the second guiding surface extend in the first direction.

4. The stylus as claimed in claim 1, wherein the hook is L-shaped.

5. The stylus as claimed in claim 1, wherein the first housing is substantially semi-cylindrical and longitudinally defines a first receiving space, the first housing includes the first inner surface in the first receiving space; the hook protrudes from the first inner surface.

6. The stylus as claimed in claim 5, wherein the second housing is substantially semi-cylindrical and longitudinally defines the second receiving space, the second housing includes a second inner surface in the second receiving space; the latching element protrudes from the second inner surface.

7. The stylus as claimed in claim 6, wherein the latching device may further includes a positioning pole and a positioning hole; the positioning pole is accommodated in the positioning hole.

8. The stylus as claimed in claim 7, wherein the positioning pole protrudes from the first inner surface and near the hook; the positioning hole is defined in the latching element and communicates with the guiding receiving space and the latching receiving space.

9. A stylus, comprising:
a first housing;
a second housing; and
a latching device comprising a hook and a latching element engaging the hook, one of the hook and the latching element protruding from an inner surface of the first housing, the other one protruding from an inner surface of the second housing;
wherein the latching element defines a guiding receiving space and a latching receiving space communicating with the guiding receiving space, the guiding receiving space is defined by a first guiding receiving space surface and a second guiding receiving space surface; when the first housing is pressed toward the second housing, the hook is biased by the first guiding receiving space surface before the hook crosses the first guiding receiving space surface; after the hook crosses the first guiding receiving space surface, the hook restores and enters into the latching receiving space so the hook is latched in the latching receiving space.

10. The stylus as claimed in claim 9, wherein the guiding receiving space extends in a first direction intersected with a longitudinal direction of the latching element.

11. The stylus as claimed in claim 9, wherein both the first guiding surface and the second guiding surface extend in the first direction.

12. The stylus as claimed in claim 9, wherein the hook is L-shaped.

13. The stylus as claimed in claim 9, wherein the first housing is substantially semi-cylindrical and longitudinally defines a first receiving space, the first housing includes the first inner surface in the first receiving space; the hook protrudes from the first inner surface.

14. The stylus as claimed in claim 13, wherein the second housing is substantially semi-cylindrical and longitudinally defines the second receiving space, the second housing includes a second inner surface in the second receiving space; the latching element protrudes from the second inner surface.

15. The stylus as claimed in claim 14, wherein the latching device may further includes a positioning pole and a positioning hole; the positioning pole is accommodated in the positioning hole.

16. The stylus as claimed in claim 15, wherein the positioning pole protrudes from the first inner surface and near the hook; the positioning hole is defined in the latching element and communicates with the guiding receiving space and the latching receiving space.
